(19) United States
(12) Patent Application Publication
(10) Pub. No.: US 2011/0264313 A1
(43) Pub. Date: Oct. 27, 2011

(54) FLIGHT PLANNING WITH DIGITAL NOTAM

(75) Inventor: Mahesh Kumar Sampath, Villupuram (IN)

(73) Assignee: HONEYWELL INTERNATIONAL INC., Morristown, NJ (US)

(21) Appl. No.: 12/765,610

(22) Filed: Apr. 22, 2010

(51) Int. Cl. G05D 1/00

(52) U.S. Cl. 701/16

(57) ABSTRACT

Provided are methods and systems for the automatic assessment and presentation of data on a display device that describes the operational impact on mission critical parameters resulting from a change in a vehicle's mission plan. The change in mission plan may be inputted manually by the vehicle operator but may also be received electronically and automatically over a data up link from an outside authority.

### TECHNICAL FIELD

The subject matter described herein relates to the automatic presentation of updated notice to airmen (“NOTAM”) data on a flight management system for display for flight planning purposes and runway verification.

### BACKGROUND

In flight, a flight crew navigates their aircraft according to a flight plan that is filed with the air traffic control authorities. The flight plan may be manually or electronically loaded into the aircraft's Flight Management System (“FMS”) at the beginning of the flight, prior to departure. Among other things, the flight plan typically includes a plurality of geographic waypoints that define a planned track of the aircraft and the specific times at which the aircraft is to arrive at those waypoints. The flight plan also comprises information concerning that availability of runways at the flight's point of origin and destination. Typically, a flight plan is updated via a air traffic control (ATC) clearance message from an ATC authority.

In the process of compiling a flight plan, the air crew is obligated to review daily message traffic referred to as a notice to airmen (“NOTAM”). A NOTAM message is a formatted digital message that is filed with an aviation authority to alert aircraft pilots of any hazards located along their flight plan or at a specific location. The authority in turn provides a means of disseminating relevant NOTAMs to pilots. In the United States, NOTAMs are available at the Federal Aviation Administration's National Airspace System Aeronautical Information Management Enterprise System (NAIMES) PilotWeb NOTAM System located on the internet at https://pilotweb.nas.faa.gov/distribution/atcscc.html.

Traditionally, pilots receive multiple NOTAMs in paper or electronic form that must be deciphered and manually evaluated Information that is relevant to their specific flight plan is then extracted by the pilot and included in the flight plan. Such, paperwork is time consuming and tedious. Further, NOTAMS that have been issued after the flight plan is created are obviously not available to the pilot during the flight planning phase. Therefore, late breaking NOTAM messages may be missed. Late breaking NOTAM updates must be transmitted to the aircraft and considered by the pilot in either electronic or paper form in flight or while preparing for departure. If a NOTAM update is found to be relevant, a decision must then be made concerning whether to modify the flight plan and how to modify the flight plan.

Such an update procedure is inefficient and may result in significant heads down time, during which the pilot's attention may be diverted from preparing the aircraft for departure or from flying the aircraft. Therefore, there is a need to improve the NOTAM update process for flight planning.

### SUMMARY

It should be appreciated that this Summary is provided to introduce a selection of exemplary non-limiting concepts. In one exemplary embodiment, a method for communicating the status of a runway located in the vicinity of a flight path to a pilot of an aircraft traveling the flight path is provided. The method comprises locating runway data associated with the closest airfield to the geographic position of the aircraft that is also in the vicinity of the flight path. The runway status at the airfield is presented to the pilot via a display device, the display comprising a symbol identifying the closest airfield along the flight path, a symbol identifying each runway located at the closest airfield along the flight path and an indication of the status of each runway at the closest air field in the vicinity of the flight path.

In another exemplary embodiment, an onboard computer system is provided. The system comprising a flight management system (FMS), a data uplink (DU); a multi-purpose command display unit (MCDU) in operable communication with the FMS and the DU and a notice to airmen (NOTAM) message database in operable communication with the FMS. A NOTAM message is received and parsed by the DU. Any runway data that is parsed from the NOTAM message is then stored in the NOTAM database. The runway data is retrieved from the NOTAM database and then displayed on the MCDU by the FMS upon receiving a query command from a pilot of the aircraft.

### BRIEF DESCRIPTION OF THE DRAWINGS

FIG. 1 is a rendition of an aircraft cockpit showing an exemplary location of a Flight Management System.

FIG. 2 illustrates an exemplary Multi-purpose Control Display Unit.

FIG. 3 illustrates a simplified, non-limiting system for implementing the subject matter describes herein.

FIG. 4 illustrates an exemplary flow chart incorporating the disclosed subject matter.

### DETAILED DESCRIPTION

The following disclosure is directed to systems and methods that automatically derive hazard and runway information from digital notice to airmen (NOTAMS) messages and provide that information to a vehicle operator. Non-limiting, examples of hazard information include but is not limited to restricted air space, closed runways, foul weather. The concepts disclosed herein are exemplary and are simplified for purposes of explanation. The embodiments disclosed are not intended to limit the scope of the Applicant's invention in any way.

The subject matter now will be described more fully below with reference to the attached drawings which are illustrative of various embodiments disclosed herein. Like numbers refer to like objects throughout the following disclosure. The attached drawings have been simplified to clarify the understanding of the systems, devices and methods disclosed. The subject matter may be embodied in a variety of forms. The exemplary configurations and descriptions, infra, are provided to more fully convey the subject matter disclosed herein.

The subject matter herein will be disclosed below in the context of an aircraft. However, it will be understood by those of ordinary skill in the art that the subject matter is similarly applicable to other types of vehicles should the need arise. Non-limiting examples of other vehicle types in which the subject matter herein below may be applied includes maritime vessels, spacecraft, watercraft and terrestrial motor vehicles. The subject matter disclosed herein may be incorporated into any suitable navigation or flight data system that currently exists or that may be developed in the future. Without limitation, terrestrial motor vehicles may also include military combat and support vehicles of any description.

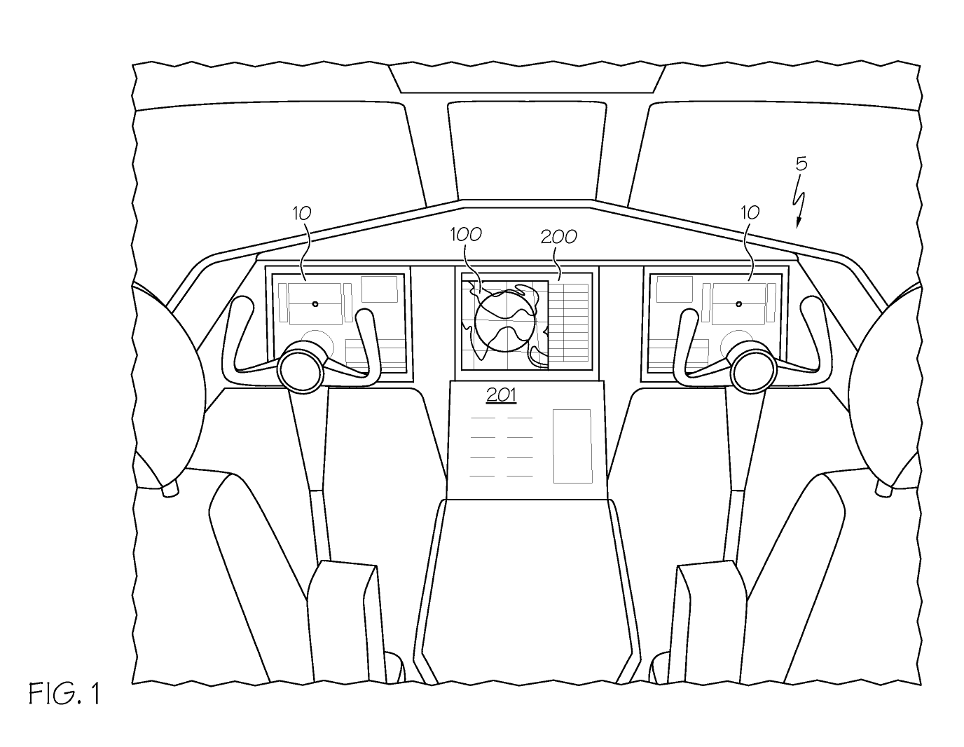

FIG. 1 is an exemplary view of a generic aircraft equipped with a Flight Management System (FMS) 5 that may communicate with, or may incorporate within itself, a multi-purpose command display unit (MCDU) 200, which may also include one or more electronic display panels 204. Generally, the FMS 5 may communicate with, or may comprise a primary flight display 10 for each of the pilot and co-pilot, which displays information for controlling the aircraft. The FMS 5 may communicate with, or may also include a navigation display 100, which may also be referred to herein as a “moving map”, which may be used in conjunction with the MCDU 200. FMS 5 and MCDU 200 may be in operable communication with data up-link unit 201. In a non-aircraft embodiment, the FMS 5 may instead be a radar console, a radar repeater or a command display.

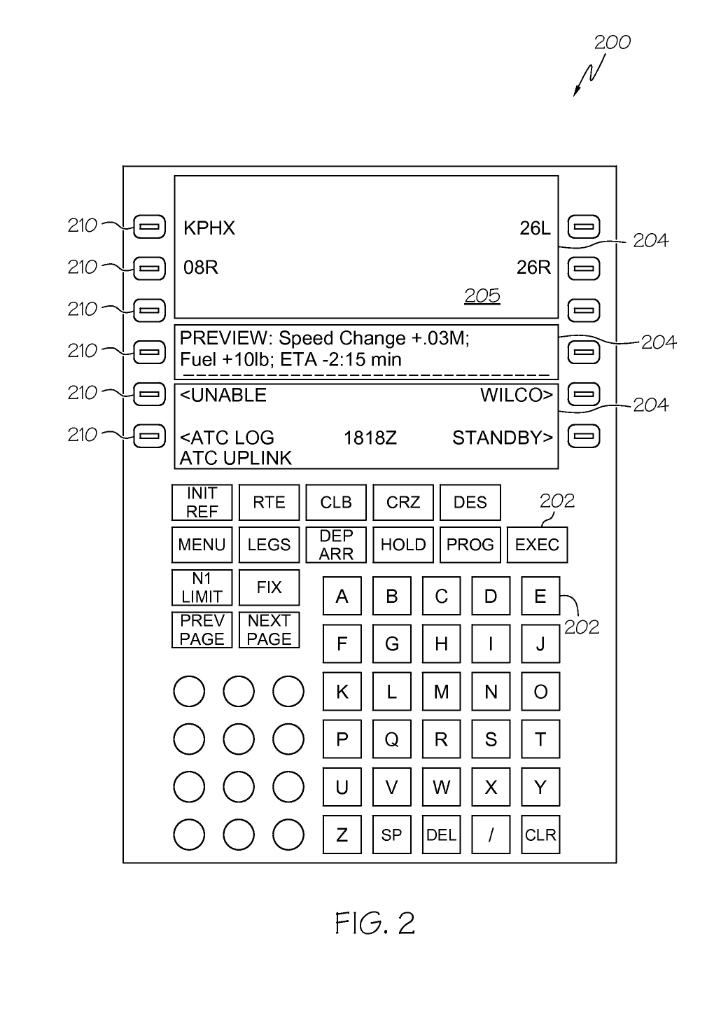

FIG. 2 is a rendition of an exemplary non-limiting exemplary MCDU 200. In one embodiment, MCDU 200 may comprise a physical display device with multiple physical input transducers (202, 210) and multiple physical display panels 204 for interfacing with the flight crew. Exemplary, non-limiting transducers (210, 202) may include push buttons, switches, knobs, touch pads and the like. Exemplary, non-limiting display panels 204 may include light emitting diode arrays, liquid crystal displays, cathode ray tubes, incandescent lamps, and the like.

In other embodiments, the MCDU 200 may be a virtual device. The display for the virtual device may be rendered on a general purpose electronic display device where the input transducers 210 and 202 and display panels 204 are electronic, graphical renditions of a physical device. Such electronic display devices may be any type of display device known in the art. Non-limiting examples of a display device may be a cathode ray tube, a liquid crystal display and a plasma screen. However, any suitable display device developed now or in the future is contemplated to be within the scope of this disclosure. Regardless of the nature of the MCDU 200, any hazard data or symbology representing hazard data may be displayed in a display panel 204, such as data 205.

In the embodiment of FIG. 2, the exemplary symbols included in airfield data 205 may comprise the four letter abbreviation “KPHX” representing a specific airfield. The symbols 08R, 26L and 26R may each represent a different runway located at airfield KPHX. Although the exemplary symbols depicted in airfield data 205 are alphanumeric in nature, the symbols may be any desired graphical, alphanumeric, pictorial, photographic, iconic or other symbology as may be desired to fit a particular requirement.

Similarly, the exemplary symbols KPHX may alternatively represent an air traffic control jurisdiction. The symbols 08R, 26L and 26R may represent specific volumes of airspace that may or may not have restrictions associated with them that exist within that jurisdiction. Although the symbology disclosed herein may represent any number of potential situations of interest to a vehicle operator or pilot, the following discussion is restricted to an airfield's runway status in the interest of brevity and clarity.

In some embodiments, the input transducers 210 that are arrayed along he sides of the MCDU 200 may be general purpose transducers the operation of which will be recognized by those skilled in the art. Generally, the transducers 210 allow a pilot to select or input information associated with symbols being rendered proximate to a specific transducer 210. For example, each of symbols 08R, 12L and 26R may represent a specific runway. Manipulating the transducer 210 proximate to one of the symbols may select the associated runway for further processing as will be described more fully below. Similarly, manipulating the transducer 210 that is proximate to the airfield symbol KPHX may confirm that the symbol KPHX is to be used as data for locating its associated runway data. Alternatively, when manipulated the transducer 210 may enable data to be entered into the display 204 at that location by further manipulating input transducers 202. For example, transducers 202 may be used to enter the symbol “KPHX.”

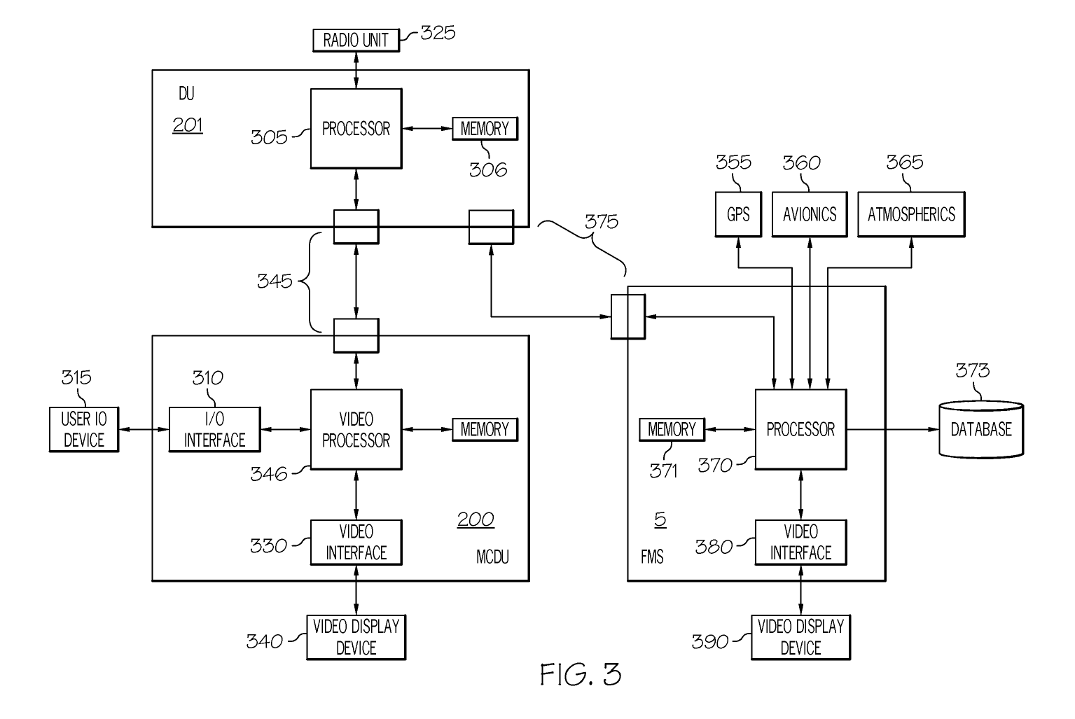

FIG. 3 depicts an exemplary system 300 that may be used to implement the subject matter described herein. Although this exemplary embodiment discloses an FMS 5, a data up-link unit 201 and a MCDU 200 as separate units, it would be readily apparent to one of ordinary skill in the art that the functions of the FMS 5, the data up-link unit 201 and the MCDU 200 may be combined into a single computing device, may be broken out into additional devices or may be distributed over a wireless or a wired network.

FMS 5 comprises a processor 370. Processor 370 may be any suitable processor or combination of sub-processors that may be known in the art. Processor 370 may comprise a central processing unit, an embedded processor, a specialized processor (e.g. digital signal processor), or any other electronic element responsible for interpretation and execution of instructions, performance of calculations and/or execution of voice recognition protocols. Processor 370 may communicate with, control and/or work in concert with, other functional components, including but not limited to a video display device 390 via a video interface 380, a geographical positioning system (GPS) 355, a database 373, one or more avionic sensor/processors 360, one or more atmospheric sensor processors 365, and/or one or more data interfaces 375/345. The processor 370 is a non-limiting example of a computer readable medium.

The processor 370, as noted above, may communicate with database 373. Database 373 may be any suitable type of database known in the art. Non-limiting exemplary types of data bases include flat databases, relational databases, and post-relational databases that may currently exist or be developed in the future. Database 373 may be recorded on any suitable type of non-volatile or volatile memory devices such as optical disk, programmable logic devices, read only memory, random access memory, flash memory and magnetic disks. The database 373 may store flight plan data, aircraft operating data, NOTAM message data, navigation data, hazard data, runway data and other data as may be operationally useful. The database 373 may be an additional, non-limiting example of a computer readable medium.

Processor 370 may include or communicate with a memory module 371. Memory module 371 may comprise any type or combination of Read Only Memory, Random Access Memory, flash memory, programmable logic devices (e.g. a programmable gate array) and/or any other suitable memory device that may currently exist or be developed in the future. The memory module 371 is a non-limiting example of a computer readable medium and may store any suitable type of information. Non-limiting, example of such information include flight plan data, flight plan change data, NOTAM message data and navigation data.

The data I/O interface 375 may be any suitable type of wired or wireless interface as may be known in the art. The data I/O interface 375 receives parsed NOTAM message information from data up-link unit 201 and forwards the parsed data to the processor 370. The I/O interface 375 also receives parameter differential data from the processor 370 and translates the parameter differential data for use by processor 305, and vice versa. Wireless interfaces, if used to implement the data I/O interface may operate using any suitable wireless protocol. Non-limiting, exemplary wireless protocols may include Wi-Fi, Bluetooth™, and Zigbee.

The data up-link unit 201 includes processor 305. Processor 305 may be any suitable processor or combination of sub-processors that may be known in the art. Processor 305 may include a central processing unit, an embedded processor, a specialized processor (e.g. digital signal processor), or any other electronic element responsible for the interpretation and execution of instructions, the performance of calculations and/or the execution of voice recognition protocols. Processor 305 may communicate with, control and/or work in concert with, other functional components including but not limited to a video display device 340 via a video processor 346 and a video interface 330, a user I/O device 315 via an I/O interface 310, one or more data interfaces 345/375 and/or a radio unit 325. I/O device 315 and video display device 340 may be components within MCDU 200 and also may include the above mentioned transducers 202, 210 and the visual display panels 204. It will be appreciated that the data-link unit 201 and the MCDU 200 may be combined into one integrated device. The processor 305 is a non-limiting example of a computer readable medium.

Processor 305 may include or communicate with a memory module 306. Memory module 306 may comprise any type or combination of Read Only Memory, Random Access Memory, flash memory, programmable logic devices (e.g. a programmable gate array) and/or any other suitable memory device that may currently exist or be developed in the future. The memory module 306 is a non-limiting example of a computer readable medium and may contain any suitable configured data. Such exemplary, non-limiting data may include flight plan data, clearance message data, hazard data, NOTAM message data, runway data and flight parameter differential data.

Processor 305 may contain instructions that when executed identifies and parses NOTAM messages received over radio unit 325. Processor 305 may then execute instructions that temporarily stores parsed NOTAM message data in memory 306 or communicates the parsed NOTAM message data to processor 370 over interface 375 for processing or for storage in database 373.

The data I/O interface 345 may be any suitable type of wired or wireless interface as may be known in the art. The data I/O interface 345 receives a parsed data clearance message from processor 305 and translates the parsed data clearance data into a format that may be readable by the video processor 346 of MCDU 200 for display in video display device 340. The data I/O interface 345 also receives pilot response information generated by user I/O device 315 via I/O interface 310 for transmission back to the flight control authority via radio unit 325 via processor 305.

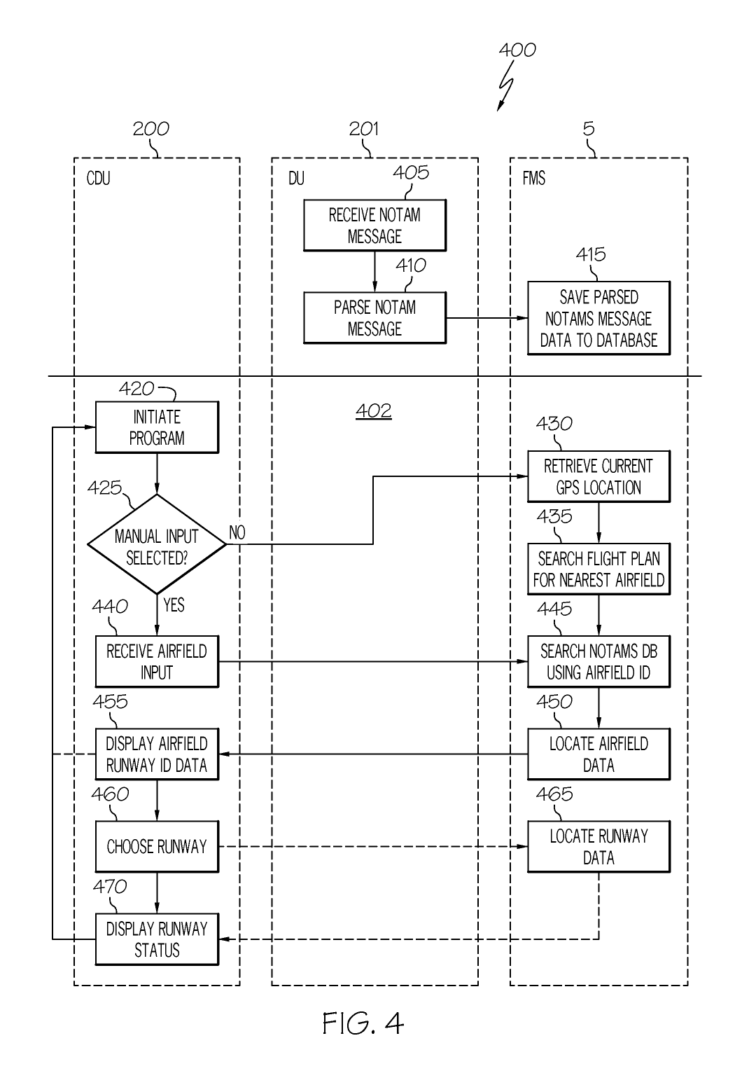

FIG. 4 is a simplified flow chart illustrating an exemplary, non-limiting method 400 for implementing the subject matter disclosed herein. One of ordinary skill in the art will recognize after reading the disclosure herein that the processes disclosed in FIG. 4 are not the only processes that may be used. Processes may be separated into their logical sub-processes, functionally equivalent processes may be substituted and processes may be combined.

As described above, the data up-link unit 201 is in operable communication with the FMS 5 and with MCDU 200. The data up-link unit 201 transmits and/or receives digital messages by radio communication means that are well known in the art. The data up-link information may be sent and received in an established syntax format with some free text narrative.

In the exemplary method 400, a digital NOTAM message may be received by the processor 305, via the radio unit 325 at process 405 and then parsed at process 410. In some embodiments the parsing may alternatively be accomplished by processor 370.

At process 415, the parsed NOTAMS message data is saved in a database. The database may reside anywhere in the aircraft. Preferably, the database resides in the FMS 5 or is in operable communication with FMS 5 such as database 373.

In another exemplary method 402, A process for presenting the NOTAMS message data to the pilot may begin at process 420. At process 425, the processor 370 determines if the pilot has selected an option as to whether the system is to automatically determine the closest airfield to the geographic position of that aircraft or whether to accept a manual input. If the automatic input option is selected then the method progresses to process 430.

At process 430, the current geographic position of the aircraft is determined. The geographic position may be determined from any number of navigation systems known in the art that are available on the aircraft such as the GPS system 355. However, other positioning systems known in the art may be used such as dead reckoning, radio triangulation, etc.

At process 435 the aircraft's current flight plan is electronically searched to identify the closest airfield to the current geographic position of the aircraft determined in process 430. To the extent that the closest airfield is a destination airfield, the destination airfield would be identified. Should the aircraft be in mid-flight, the nearest airfield may be a military facility or and airport identified as a waypoint in the aircraft's flight plan or one within a predetermined distance from the active route defined in the flight plan.

At process 425, if a manual input is selected then the method progresses to process 440. At process 440, the pilot may manually input a specific airfield. The input may be accomplished by manipulating the transducers 202 and 210 on MCDU 200 as may be known in the art.

Whether an airfield is determined by manual input or determined automatically, the symbol identifying the airfield (e.g. KPHX) may serve as an index for searching the NOTAMS database 373 for any information concerning that particular airfield. At process 445, the NOTAM database 373 is searched for information concerning the identified airfield KPHX. For example, such data may include the number of runways and an up to date status of each runway. The up to date status of each runway may have been received automatically while in flight via the DU 201 as disclosed above in regard to exemplary method 400.

At process 450 the desired airfield data is located by the FMS 5 and communicated to the MCDU 200 for display. In some embodiments, only the airfield identification data may be located and communicated. In other embodiments, runway identification data, runway status data and other data associated with the identified airfield may be located and communicated to the MCDU 200. Such data may be temporarily stored in MCDU 200 memory 348.

At process 455, the airfield data 205 is displayed including the various runways located at the airfield. In some embodiments, the displayed runway data may also include the up to date runway status as part of the display.

In embodiments where runway status data is communicated to the MCDU 200 along with the airfield data for display at process 455, then the method 402 may terminate at this point. However, in embodiments where runway status data is not communicated to the MCDU 200 for display at process 455, the pilot may choose the runway of interest at process 460. The choice may be made by manipulating the transducer 210 associated with a displayed runway symbol.

Once a runway choice is made at process 460, runway data is located by searching the NOTAMS database 373 or by retrieving the information from the local MCDU memory 348. To the extent that the runway status data was not communicated to the MCDU 200 at process 450, the runway status data is located and communicated to the MCDU 200 at process 465. Otherwise, process 465 may be omitted.

At process 470 the up-to-date runway status data is displayed to the pilot via the MCDU 200. The up-to-date runway status may be indicated by an additional symbol data associated with each runway identified or may be indicated by altering the color of the runway symbol.

For example, referring back to airfield data 205 in FIG. 2, the runway symbology 08R, 26L and 26R may be rendered in a green color if all of the runways are in an available status. Any runways that may be closed may be rendered in a red color. Similarly, runways where the status is unknown, ambiguous or may be open but degraded (e.g. the runway is too small for the aircraft except in an emergency or may be obstructed) may be rendered in yellow. The possibilities, combination and permutations available possible symbology and its presentation are manifold and are may be left to the discretion of a systems designer or regulation.

The subject matter described above is provided by way of illustration only and should not be construed as being limiting. Various modifications and changes may be made to the subject matter described herein without following the example embodiments and applications illustrated and described, and without departing from the true spirit and scope of the present invention, which is set forth in the following claims.

What is claimed is:

1. A method for communicating the status of a runway located in the vicinity of a flight path to a pilot of an aircraft traveling the flight path, the method comprising the steps of:
locating a closest airfield in the vicinity of the flight path to the geographic position of the aircraft;
presenting a display to the pilot via a display device, the display comprising a symbol identifying the closest airfield along the flight path, a symbol identifying each runway located at the closest airfield along the flight path and an indication of the status of each runway at the closest air field in the vicinity of the flight path.

2. The method of claim 1, wherein the closest airfield along the flight path is selectable by the pilot.

3. The method of claim 1, further comprising creating and storing a flight plan to a database, the flight plan including the flight path and a destination airfield at the end of the flight path.

4. The method of claim 3, further comprising:
receiving an electronic message;
parsing the electronic message; and
storing data parsed from the electronic message to the database, the data including a geographic position of an airfield along the flight path and electronic runway status information associated with the airfield.

5. The method of claim 4, wherein the message containing the electronic runway status information is a digital notice to airman (NOTAM) message.

6. The method of claim 1, wherein the display is one of a multi-function control display unit (MCDU) and a virtual MCDU.

7. The method of claim 5, wherein locating the closest airfield along the flight path includes:
determining the geographic position of the aircraft;
searching the database by the geographic position of the aircraft; and
determining the airfield closest to the geographic position of the aircraft.

8. The method of claim 6, wherein presenting the display to the pilot includes rendering on the display device the symbol representing the airfield and each symbol representing a runway at the airfield, each runway symbol and airfield symbol being associated with its own user interface whereby the pilot may select the airfield and a runway.

9. The method of claim 8, wherein multiple airfields and their associated runways are rendered on the same display when the multiple airfields are substantially equidistant from the flight path substantially simultaneously.

10. The method of claim 8, wherein manipulating a user interface associated with a runway symbol initiates the steps of:
retrieving electronic runway status information associated with the selected runway symbol from the database; and
rendering a runway status indication on the display device.

11. A method for communicating the status of a runway located along a flight path to a pilot of an aircraft traveling the flight path, the method comprising the steps of:
creating a notice to airmen (NOTAM) database in communication with a flight management system (FMS), the NOTAM database comprising at least airfield information, runway information associated with the airfield information and runway status information associated with the runway information;
automatically updating the NOTAM database;
upon a command from the pilot, searching the NOTAM database for runway status information associated with the closest airfield to a current geographic location of the aircraft; and
rendering the runway status information associated with the closest airfield to the pilot by the FMS via a multi-function control display unit (MCDU) in communication with the FMS.

12. The method of claim 11, wherein automatically updating the NOTAM database is accomplished by:
receiving additional NOTAM messages via a data up-link (DU);
parsing the additional NOTAM messages to extract additional runway information and runway status information; and
adding the additional runway information and runway status information to the NOTAM database.

13. The method of claim 11, further comprising determining the closest airfield to the geographic position of the aircraft.

14. The method of claim 13, wherein information associated with multiple airfields and their associated runways are rendered on the MCDU when the multiple airfields are substantially equidistant from the flight path substantially simultaneously.

15. The method of claim 13, wherein the closest airfield is selectable by the pilot.

16. The method of claim 13, wherein locating the closest airfield includes:
determining the geographic position of the aircraft;
searching the database by the geographic position of the aircraft; and
determining the airfield closest to the geographic position of the aircraft.

17. The method of claim 11, wherein presenting the display on the MCDU to the pilot includes rendering on the display device a symbol representing the airfield and a symbol representing each runway at the airfield, each runway symbol and airfield symbol being associated with its own user interface whereby the pilot may select the airfield and a runway.

18. The method of claim 17, wherein manipulating a user interface associated with a runway symbol initiates the steps of:
retrieving electronic runway status information associated with the selected runway symbol from the database; and
rendering a runway status indication on the display device.

19. The method of claim 18, wherein the command from the pilot comprises manipulating the user interface associated with a specific symbol representing a runway.

20. An computer system onboard an aircraft comprising;
a data uplink (DU) configured to receive and to parse a NOTAM message;
a multipurpose command display unit (MCDU) in operable communication with the DU and configured to display runway data parsed from the NOTAM message;
a notice to airmen (NOTAM) message database configured to receive and store the parsed runway data from the DU; and
a flight management system (FMS) configure to retrieve the runway data from the NOTAM database and then display the runway data on the MCDU upon receiving a command from a pilot of the aircraft.
